(19) United States
(12) Patent Application Publication
(10) Pub. No.: US 2007/0172187 A1
(43) Pub. Date: Jul. 26, 2007

(54) Optical sheet body and its producing method, optical card and composite memory

(75) Inventors: Yasuhiko Hatakeyama, Nagano (JP); Mikio Horiuchi, Tokyo (JP)

Correspondence Address: BUCHANAN, INGERSOLL & ROONEY PC, POST OFFICE BOX 1404, ALEXANDRIA, VA, 22313-1404, US

(73) Assignees: HATAKENSAKU CO., LTD, Minamiazumi-gun (JP); EMPIRE AIRPORT SERVICES CO., LTD., Tokyo (JP)

(21) Appl. No.: 10/581,798

(22) PCT Filed: Dec. 3, 2003
(86) PCT No.: PCT/JP03/15496

§ 371 Date: Feb. 21, 2007

(51) Int. Cl. G02B 6/10

(52) U.S. Cl. 385/130

(57) ABSTRACT

An optical card (1) comprising a surface protection sheet (4) laid on the surface (2a) of a core sheet (2) through a surface side adhesive layer (3) functioning as a surface-side clad layer, and a back surface protection sheet (6) laid on the back surface (2b) through a back surface side adhesive layer (5) functioning as a back surface-side clad layer, wherein a large number of V-grooves (7) are made, at a constant interval, in the surface (2a) of the core sheet (2) and the opposite ends (7a, 7b) of each V-groove are exposed to the end faces (2c,2d) of the sheet. Sectional parts (8(2), 8(4), . . . ) of the core sheet (2) formed between respective grooves (7) function as optical waveguides and remaining sectional parts (8(1), 8(3), . . . ) each provided with a V-groove (light shielding groove) (9) extending across adjacent V-grooves (7), function as non-optical waveguides. An inexpensive and highly durable optical card (1) having optical waveguides and non-optical waveguides formed with high accuracy can thereby be provided without using an optical fiber.

### TECHNICAL FIELD

The present invention relates to an optical sheet body that is capable of supporting information by means of an optical waveguide and a non-optical waveguide, and to a producing method thereof. The present invention also relates to an optical card and a composite memory card that use this sheet body.

### BACKGROUND ART

Magnetic cards are used in various applications as credit cards, membership cards, or pre-paid cards such as telephone cards and pachinko cards. However, recently the information supported on the magnetic stripes has been read incorrectly, and forged or falsified counterfeit magnetic cards have often been used illegally, bringing the reliability of magnetic cards into question.

In order to improve the reliability of magnetic cards, one of the present applicants has proposed a memory card having a configuration in which a large number of optical fibers are embedded in a magnetic card, and any number of these fibers are either cut or crushed, whereby an optical storage region composed of a combination of light-transmitting and light-blocking areas is formed in the magnetic card (Patent Documents 1, 2). This memory card has a structure in which a core member is formed by aligning optical fibers having a circular or polygonal cross-sectional shape on a plane and integrating the fibers with an adhesive, and a protection sheet made of plastic is bonded to both sides of the core member.

Once the optical fibers are cut or crushed, it is substantially impossible to repair this portion to obtain the original light transmission characteristics. Therefore, it is difficult to forge or falsify a memory card having a configuration in which the optical storage region is formed on a magnetic card, and it is possible to easily determine whether the card is counterfeit by double-checking the information stored in the magnetic storage region and the optical storage region. Accordingly, such memory cards are very reliable.

Patent Document 1] U.S. Pat. No. 2682542

Patent Document 2] U.S. Pat. No. 2737841

### DISCLOSURE OF INVENTION

Problems the Invention is Intended to Solve

However, such memory cards have the following problems because optical fibers are used to form an optical storage region composed of a combination of light-transmitting and light-blocking areas.

First, it is difficult to bond and fix a large number of optical fibers, about 30 to 200, for example, while aligning the fibers with high accuracy at equal pitches in one card in a planar direction. Accordingly, the memory card has poor production efficiency.

Also, since the bonding strength between optical fibers depends on the adhesive strength, it is highly possible that the bonding strength of the optical fibers will be insufficient in practice. Particularly, when a force acts on the memory card, causing it to bend and deform, the core member having a structure in which the optical fibers are bonded and fixed in a planar direction is likely to break.

Furthermore, optical fibers are normally expensive, and memory cards in which an optical storage region is formed using a large number of optical fibers are also expensive and are impractical.

In view of these circumstances, an object of the present invention is to provide an optical sheet body in which an optical storage region is formed without the use of optical fibers, and also to provide a method for producing an optical sheet body.

Another object of the present invention is to provide an optical card and a composite memory card that use this new optical sheet body.

Means for Solving These Problems

The optical sheet body of the present invention is characterized in comprising:

a transparent core sheet having a prescribed thickness;

a plurality of grooves formed in the core sheet;

a surface side clad layer formed on the surface of the core sheet; and

a back-surface side clad layer formed on the back surface of the core sheet; wherein

the grooves have a depth that substantially corresponds to the thickness of the core sheet;

the ends of the grooves are exposed at the end faces of the core sheet; and

the sectional parts of the core sheet that are formed between adjacent grooves serve as optical waveguides.

With the optical sheet body of the present invention, forming grooves in a core sheet made of transparent plastic or the like results in sectional parts being formed between the grooves, and the surfaces and back surfaces of the sectional parts are covered by a clad layer. Therefore, the sectional parts function as optical waveguides that guide the light directed from one end to the other end. Accordingly, an optical storage region can be formed without the use of optical fibers.

In the present invention, in order to form non-optical waveguides that do not allow light to pass, light-blocking grooves having a depth that substantially corresponds to the thickness of the core sheet can be formed in the sectional parts so as to span the length between adjacent grooves. The light directed from one end face of the sectional parts is blocked out by the light-blocking grooves and is not guided to the other end face. Accordingly, it is possible to form an optical storage region that is capable of supporting information and that is composed of a combination of optical waveguides and non-optical waveguides.

V-grooves can herein be used for both the grooves and the light-blocking grooves.

Generally, the grooves can be formed in parallel at prescribed intervals, and optical waveguides and non-optical waveguides that are sectioned off by these grooves can be formed in linear fashion at a constant width.

Furthermore, the outline shape of the core sheet can generally be a rectangular shape. Of course, it is also possible for the outline to be circular, polygonal, or another such shape.

Next, in order to protect the core sheet on which the optical waveguides and non-optical waveguides are formed, it is preferable that the optical wave body have a surface protection sheet covering the surface side clad layer, and a back-surface protection sheet covering the back-surface side clad layer.

In this case, there is no need to form the clad layer and the adhesive layer separately if the surface side clad layer is formed as a surface-side adhesive layer whereby the core sheet and the surface protection sheet are bonded together, and if the back-surface side clad layer is formed as a back-surface-side adhesive layer whereby the core sheet and the back-surface protection sheet are bonded together. Manufacturing is therefore simplified.

Also, it is preferable that at least one sheet selected from the surface protection sheet and the back-surface protection sheet be a semitransparent sheet, and that the surface-side adhesive layer and the back-surface-side adhesive layer be ultraviolet-curing adhesives. A semitransparent sheet allows ultraviolet rays to sufficiently pass through in the thickness direction, but does not allow light to substantially pass through in a planar direction because the distance is greater in this direction. Accordingly, a semitransparent sheet can function as a clad layer, and can also bond the core sheet and the protection sheets together simply and in a short amount of time by exposure of the semitransparent sheet to ultraviolet rays on the exterior.

Next, it is preferable that a highly adhesive PET sheet be used as the core sheet.

The present invention is a method for producing the optical sheet body having the configuration described above, the method being characterized in comprising:

applying the ultraviolet-curing adhesive to the surface of the back-surface protection sheet;

laminating the core sheet that does not yet have the grooves or the light-blocking grooves to the surface of the back-surface protection sheet so that the ultraviolet-curing adhesive is interposed therebetween;

exposing the surface side of the core sheet to ultraviolet rays to cure the ultraviolet-curing adhesive, forming the back-surface-side adhesive layer, and laminating and bonding the back-surface protection sheet to the back-surface side of the core sheet by means of the back-surface-side adhesive layer;

forming the V-grooves and the light-blocking grooves in the core sheet from the front surface side of the core sheet;

applying the ultraviolet-curing adhesive to the surface of the core sheet;

laminating the surface protection sheet to the surface of the core sheet so that the ultraviolet-curing adhesive is interposed therebetween; and

exposing the surface side of the surface protection sheet to ultraviolet rays to cure the ultraviolet-curing adhesive, forming the surface-side adhesive layer, and laminating and bonding the surface protection sheet to the surface side of the core sheet by means of the surface-side adhesive layer.

With the method of the present invention, only one side need be exposed to ultraviolet rays, and the grooves and light-blocking grooves can be formed from the same side. Manufacturing is therefore simplified.

In order to efficiently form the grooves and light-blocking grooves on the core sheet, a rotary die can be used. The grooves and light-blocking grooves can also be formed by laser cutting.

Next, the optical card of the present invention is characterized in having:

a rectangular optical sheet body having the configuration described above; wherein

both end faces of the optical waveguides and the non-optical waveguides are positioned at the longitudinal end faces or the transverse end faces of the optical sheet body.

Also, the composite card of the present invention is characterized in having the optical card which has the configuration described above, and a magnetic storage unit.

Another possibility is a configuration that includes an IC memory chip either in place of or in addition to the magnetic card.

### BRIEF DESCRIPTION OF DRAWINGS

FIGS. 1(a) and (b) are, respectively, a perspective view showing an optical card in which the present invention is applied and an explanatory diagram showing the internal structure;

FIG. 2 is a plan view showing the core sheet in FIG. 1;

FIGS. 3(a), (b), and (c) are explanatory diagrams showing the process of producing the optical card shown in FIG. 1;

FIG. 4 is an explanatory diagram showing the rotary die used to form V-grooves in the optical card; and

FIG. 5 is an explanatory diagram showing two examples of a composite memory card according to the present invention.

### BEST MODE FOR CARRYING OUT THE INVENTION

Embodiments of the present invention will now be described with reference to the drawings.

Opptical Card

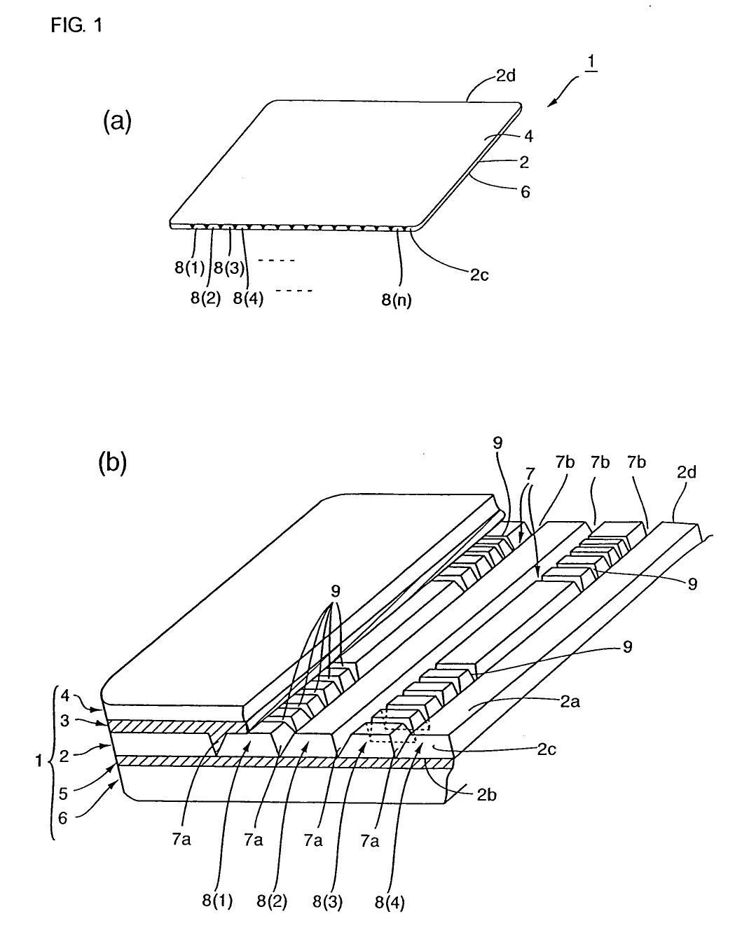

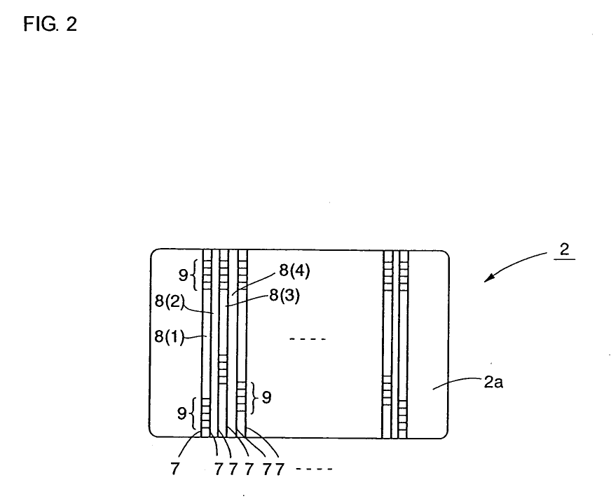

FIGS. 1(a) and (b) are, respectively, a perspective view showing an optical card in which the present invention is applied and an explanatory diagram showing the internal structure; and FIG. 2 is a plan view showing a core sheet of the optical card.

An optical card 1 is formed from an optical sheet body having a thin, rectangular multi-layered structure, and includes a core sheet 2, a surface protection sheet 4 laminated and bonded to the surface 2a of the core sheet 2 by means of a surface-side adhesive layer 3 that functions as a surface-side clad layer, and a back-surface protection sheet 6 laminated and bonded to the back surface 2b of the core sheet 2 by means of a back-surface-side adhesive layer 5 that functions as a back-surface-side clad layer. A large number of V-grooves 7 that extend in the width direction of the sheet are formed at constant intervals in the surface 2a of the core sheet 2. The opposite ends 7a, 7b of each V-groove are exposed on the sheet end faces 2c, 2d at the lengthwise ends of the core sheet 2.

Among the sectional parts 8(1), 8(2), 8(3), . . . 8(n) (n: positive integer) of the core sheet 2 formed between the grooves 7, the sectional parts 8(1), 8(3), . . . , for example, are provided with V-grooves (light-blocking grooves) 9 that extend between adjacent V-grooves 7, and that are aligned in the direction orthogonal to these V-grooves 7. The sectional parts 8(2), 8(4), . . . that are not provided with V-grooves 9 function as optical waveguides and are used to guide light directed from one sheet end face 2c onto the other sheet end face 2d. The sectional parts 8(1), 8(3), . . . that are provided with V-grooves 9 function as non-optical waveguides, whereby light directed from the other sheet end face 2c is prevented from passing through by the V-grooves 9 and is not led to the other sheet end face 2d. Accordingly, the alignment pattern formed on the optical card 1 can be read if optical waveguides and non-optical waveguides are formed according to a specified alignment, detected light is directed from the sheet end face 2c to the sectional parts 8(1) to 8(n), and the presence or absence of light emitted from the sectional parts 8(1) to 8(n) is detected by a light detector disposed on the side of the sheet end face 2d.

In the present example, a transparent PET sheet having a thickness of 50 μm is used as the core sheet 2, a semitransparent PET sheet having a thickness of 125 μm is used as the surface protection sheet 4, and a white PET sheet having a thickness of 75 μm is used as the back-surface protection sheet 6. Ultraviolet-curing resins are used as the surface-side adhesive layer 3 and the back-surface-side adhesive layer 5. Furthermore, the V-grooves 7 are formed at a pitch of 1 mm, with the angle between the inclined surfaces on both sides at about 60 degrees, and with a depth substantially equal to the thickness of the core sheet 2. The V-grooves 7 are formed by pushing the blade end of a rotary die or the like from the surface 2a of the core sheet 2 as will be described later, while the portions that face the back surface 2b of the core sheet 2 are connected to each other.

The V-grooves 9 that are orthogonal to the V-grooves 7 have the same dimensions. The sectional parts 8(1), 8(3), . . . that function as non-optical waveguides are each provided with five V-grooves at a pitch of 2 mm on the side of the sheet end face 2c, and also five V-grooves at a pitch of 2 mm on the side of the other sheet end face 2d. If V-grooves 9 are formed at both ends of the sectional parts 8(1), 8(3), . . . in this manner, then it is possible to form non-optical waveguides that are capable of completely blocking out incident light. Specifically, the light directed from the sheet end face 2c is diffused and mostly attenuated by the first five V-grooves 9, and is then completely blocked out by the next five V-grooves 9.

Thus, the optical card 1 of the present example can be manufactured inexpensively because optical waveguides and non-optical waveguides can be formed without using an expensive optical fiber. Also, optical waveguides and non-optical waveguides are formed by forming V-grooves 7 and V-grooves 9 in the core sheet 2 on the front side, forming a surface-side adhesive layer 3 that functions as a clad layer on the front surface of the core sheet 2 so that the adhesive layer fills in the V-grooves 7, 9, and forming a back-surface-side adhesive layer 5 that functions as a clad layer on the back-surface side. Therefore, optical waveguides and non-optical waveguides can be formed more easily and with higher accuracy than in a memory card having a configuration in which optical fibers are bonded and fixed at equal pitches in a planar direction, and strength and durability are also enhanced.

Method for Producing Optical Card

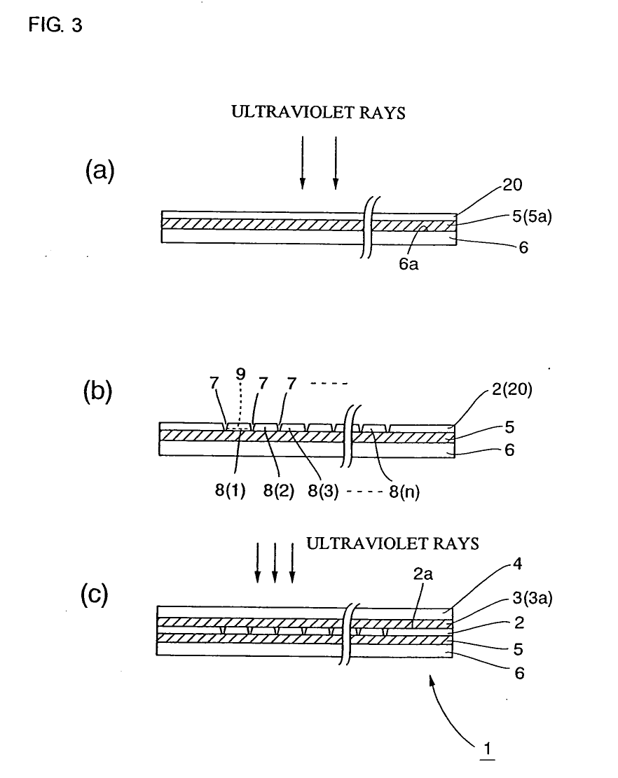

FIGS. 3(a), (b), and (c) are explanatory diagrams showing the process of producing the optical card 1. First, the back-surface protection sheet 6 is prepared, an ultraviolet-curing resin 5a is applied with a uniform thickness over the surface 6a, and a core sheet material 20 that will form the core sheet 2 is laminated to the resin, as shown in FIG. 3(a). In this state, the front surface side of the core sheet material 20 is exposed to ultraviolet rays to cure the ultraviolet-curing resin 5a. As a result, the back-surface-side adhesive layer 5 is formed, and the back-surface protection sheet 6 is laminated and bonded to the back-surface side of the core sheet material 20 by means of the back-surface-side adhesive layer 5.

Next, as shown in FIG. 3(b), the V-grooves 7 and 9 are carved out in the surface 20a of the core sheet material 20, resulting in a core sheet 2 that includes sectional parts 8(1)-8(n) that function as optical waveguides and non-optical waveguides.

The surface 2a of the core sheet 2 is then coated with an ultraviolet-curing resin 3a, as shown in FIG. 3(c). The ultraviolet-curing resin 3a is applied over the surface 2a of the core sheet 2 in a manner such that the resin is filled into the V-grooves 7, 9 formed in the surface 2a of the core sheet 2. The semitransparent surface protection sheet 4 is then laminated thereon. Moreover, the surface protection sheet 4 is exposed to ultraviolet rays from the front surface side. Ultraviolet rays pass through the surface protection sheet 4 and reach the ultraviolet-curing resin 3a. Therefore, the ultraviolet-curing resin 3a is cured, the surface-side adhesive layer 3 is formed, and the surface-side adhesive layer 3 is laminated and bonded to the front surface side of the core sheet 2 by means of the ultraviolet-curing resin 3a. Thus, the optical card 1 is completed.

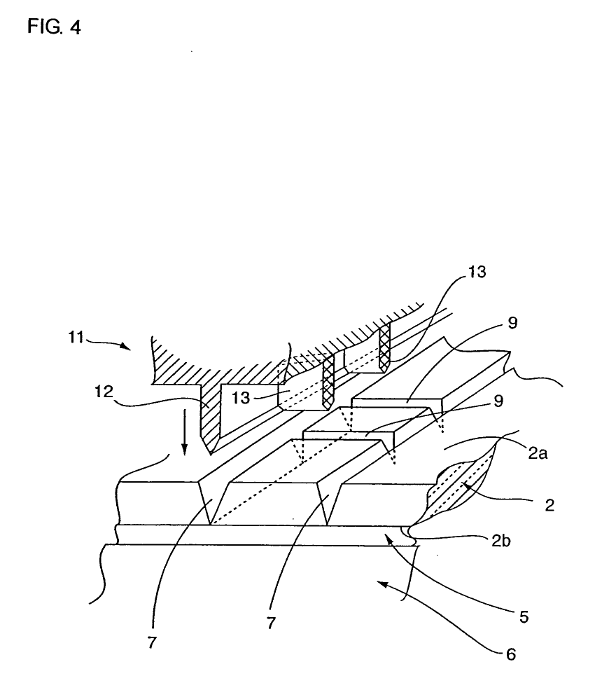

FIG. 4 is an explanatory diagram showing an example of a rotary die that is suitable for use in order to form the V-grooves 7, 9. Thirty-two aligned blades 12 that have blade end angles of 60 degrees and lengths of 80 mm, and that extend parallel at a pitch of 1 mm, are formed by etching in this rotary die 11. The V-grooves 7 are formed by these aligned blades 12. Also, five orthogonal blades 13 of the same dimensions are similarly formed by etching at a pitch of 2 mm so that they span the length between the aligned blades 12 in the orthogonal direction. The V-grooves 9 are formed by these orthogonal blades 13. The grooves 7, 9 are formed by using the rotary die 11 having this configuration to force the aligned blades 12 and the orthogonal blades 13 into the surface 20a of the core sheet material 20 by a distance proportionate to the thickness of the core sheet material 20.

Thus, in the optical card 1 of the present example, a semitransparent sheet is used as the surface protection sheet, and the surface-side adhesive layer 3 and back-surface-side adhesive layer 5 are formed using ultraviolet-curing resins. Therefore, only one side need be exposed to ultraviolet rays in the manufacturing process. Also, the V-grooves 7, 9 can be formed from the same side by forcing in the die. Manufacturing is therefore is simplified. Also, using the rotary die makes it possible to form the V-grooves 7, 9 with high accuracy and high efficiency.

Composite Memory Card

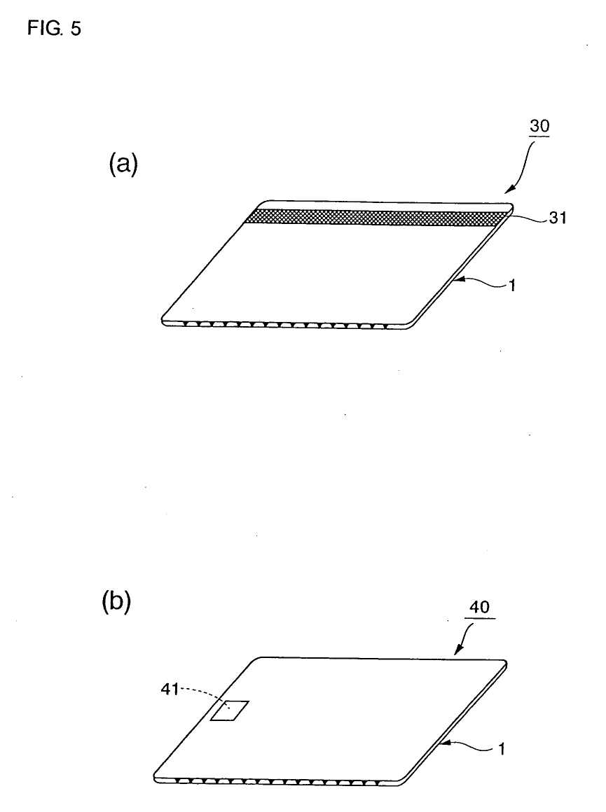

FIG. 5 depicts a structural example of a composite memory card that uses the optical card 1 of the present example. The composite memory card 30 depicted in FIG. 5(a) comprises an optical card 1, and a magnetic stripe 31 that is printed on the surface 1a thereof at a fixed width in the longitudinal direction. This composite memory card 30 can be used as an ID card or pre-paid card, for example.

A composite memory card 40 shown in FIG. 5(b) has a structure in which an IC chip 41 with a CPU is embedded between the core sheet of an optical card 1 and a surface protection sheet. This composite memory card 40 can be used as an electronic money card, an insurance card, a driver's license, or another such card that stores large amounts of information.

Other Embodiments

The example described above illustrates one example of the present invention. However, the optical sheet body and production method of the present invention, as well as the configurations of the optical card and the composite memory card are not limited to the shapes, structures, and elements in the example described above. For example, the optical sheet body may have a circular or polygonal outline instead of a rectangular outline. Also, U-grooves or other such grooves with a different cross-sectional shape can be used instead of the V-grooves. Furthermore, it is possible to use an adhesive other than an ultraviolet-curing adhesive as the surface-side adhesive layer and the back-surface-side adhesive layer. A resin other than PET can also be used as the material for the core sheet, the surface protection sheet, and the back-surface protection sheet. The grooves may also be formed by laser cutting instead of using a rotary die.

### INDUSTRIAL APPLICABILITY

As described above, in the optical sheet body of the present invention, optical waveguides are formed by forming grooves in a core sheet composed of a PET sheet or the like without cutting the core sheet, and non-optical waveguides are formed by forming light-blocking grooves in the core sheet, also without cutting the core sheet. Therefore, the optical sheet body can be manufactured more easily and at lower cost than a conventional memory card in which optical waveguides and non-optical waveguides are formed by bonding and fixing expensive optical fibers while aligning them in a planar direction. Also, it is possible to obtain an optical sheet body in which optical waveguides and non-optical waveguides are formed with high accuracy, because it is easier to form grooves with high accuracy in the core sheet by using a rotary die or the like, than in cases in which optical fibers are aligned in a planar direction. Furthermore, there are also the advantages of high flexural strength and high durability.

Also, with the method for producing an optical sheet body of the present invention, a protective sheet can be laminated and bonded to both sides of the core sheet by exposing one side to ultraviolet rays, and both grooves and light-blocking grooves can be formed on the same side. Therefore, manufacture can be simplified and production efficiency can be increased.

Furthermore, the optical card and composite memory card of the present invention can be manufactured simply and inexpensively and provided with superior flexural strength and durability by the use of an optical sheet body in which optical waveguides and non-optical waveguides are formed without the use of optical fibers.

1. An optical sheet body comprising:
a transparent core sheet having a prescribed thickness;
a plurality of grooves form in the core sheet;
a surface side clad layer formed on a surface of the core sheet, and
a back-surface side clad layer formed on ae back surface of the core sheet; wherein
the grooves have a depth that substantially corresponds to a thickness of the core sheet;
both ends of the grooves are exposed at end faces of the core sheet; and sectional parts of the core sheet that are formed between adjacent grooves serve as optical waveguides.

2. The optical sheet body according to claim 1, comprising at least one light blocking groove formed in at least one of the sectional parts; wherein
the light-blocking grooves have a depth that substantially corresponds to the thickness of the core sheet;
the light-blocking grooves span the length between adjacent grooves; and
the sectional parts on which the light-blocking grooves are formed serve as non-optical waveguides.

3. The optical sheet body according to claim 2, wherein the grooves and the light-blocking grooves are both V-grooves.

4. The optical sheet body according to claim 3, wherein the grooves are formed in parallel at prescribed intervals.

5. The optical sheet body according to claim 4, wherein the core sheet has a rectangular shape.

6. The optical sheet body according to claim 5, comprising:
a surface protection sheet that covers the surface side clad layer; and
a back-surface protection sheet that covers the back-surface side clad layer.

7. The optical sheet body according to claim 6, wherein
the surface side clad layer is a surface-side adhesive layer whereby the core sheet and the surface protection sheet are bonded together; and
the back-surface side clad layer is a back-surface-side adhesive layer whereby the core sheet and the back-surface protection sheet are bonded together.

8. The optical sheet body according to claim 7, wherein
at least one sheet selected from the surface protection sheet and the back-surface protection sheet is a semitransparent sheet; and
the surface-side adhesive layer and the back-surface-side adhesive layer are untraviolet-curing adhesives.

9. The optical sheet body according to claim 8, wherein the core sheet is a PET sheet.

10. The method for producing an optical sheet body according to claim 9, comprising:
applying the ultraviolet-curing adhesive to the surface of the back-surface protection sheet;
laminating the core sheet that does not yet have the grooves or the light-blocking grooves to the surface of the back-surface protection sheet so that the ultraviolet-curing adhesive is interposed therebetween;
exposing the surface side of the core sheet to ultraviolet rays to cure the ultraviolet-curing adhesive, forming the back-surface-side adhesive layer, and laminating and bonding the back-surface protection sheet to the back-surface side of the core sheet by means of the back-surface-side adhesive layer;
forming the V-grooves and the light-blocking grooves in the core sheet from the front surface side of the core sheet;
applying the ultraviolet-curing adhesive to the surface of the core sheet;
laminating the surface protection sheet to the surface of the core sheet so that the ultraviolet-curing adhesive is interposed therebetween; and
exposing the surface side of the surface protection sheet to ultraviolet rays to cure the ultraviolet-curing adhesive, forming the surface-side adhesive layer, and laminating and bonding the surface protection sheet to the surface side of the core sheet by means of the surface-side adhesive layer.

11. The method for producing an optical sheet body according to claim 10, wherein the V-grooves and the light-blocking grooves are formed in the core sheet by using a rotary die or a laser cutter.

12. An optical card which has a rectangular optical sheet body, wherein the optical sheet body is the optical sheet body according to claim 2; and
both end faces of the optical waveguides and the non-optical waveguides are positioned at longitudinal end faces or transverse end faces of the optical sheet body.

13. A composite memory card, comprising:
the optical card according to claim 12; and
a magnetic storage unit.

14. A composite memory card, comprising:
the optical card according to claim 12; and an IC memory chip.

15. An optical card which has a rectangular optical sheet body, wherein the optical sheet body is the optical sheet body according to claim 3; and
both end faces of the optical waveguides and the non-optical waveguides are positioned at longitudinal end faces or transverse end faces of the optical sheet body.

16. An optical card which has a rectangular optical sheet body, wherein the optical sheet body is the optical sheet body according to claim 4; and
both end faces of the optical waveguides and the non-optical waveguides are positioned at longitudinal end faces or transverse end faces of the optical sheet body.

17. An optical card which has a rectangular optical sheet body, wherein the optical sheet body is the optical sheet body according to claim 5; and
both end faces of the optical waveguides and the non-optical waveguides are positioned at longitudinal end faces or transverse end faces of the optical sheet body.

18. An optical card which has a rectangular optical sheet body, wherein the optical sheet body is the optical sheet body according to claim 6; and
both end faces of the optical waveguides and the non-optical waveguides are positioned at longitudinal end faces or transverse end faces of the optical sheet body.

19. An optical card which has a rectangular optical sheet body, wherein the optical sheet body is the optical sheet body according to claim 7; and
both end faces of the optical waveguides and the non-optical waveguides are positioned at longitudinal end faces or transverse end faces of the optical sheet body.

20. An optical card which has a rectangular optical sheet body, wherein the optical sheet body is the optical sheet body according to claim 8; and
both end faces of the optical waveguides and the non-optical waveguides are positioned at longitudinal end faces or transverse end faces of the optical sheet body.
